(19) United States
(12) Patent Application Publication
(10) Pub. No.: US 2026/0108924 A1
(43) Pub. Date: Apr. 23, 2026

(54) PORTABLE FUME EXTRACTOR

(71) Applicant: Superior Air Products, LLC, Goddard, KS (US)

(72) Inventor: Jim Orr, Wichita, KS (US)

(21) Appl. No.: 19/363,165

(22) Filed: Oct. 20, 2025

Related U.S. Application Data
(60) Provisional application No. 63/710,012, filed on Oct. 21, 2024.

(51) Int. Cl. B08B 15/04

(52) U.S. Cl. CPC B08B 15/04

(57) ABSTRACT

A portable fume collection system is provided for capturing fumes, dust and gaseous and particulate matter created during welding and other applications. The portable fume collection system includes a downdraft table component and a fume capture arm component. The portable fume collection system includes a frame with an interior housing a motor and a fan for generating reverse airflow at the downdraft table component and the fume capture arm component.

### CROSS-REFERENCE TO RELATED APPLICATIONS

This application claims priority to U.S. Provisional Patent Application Ser. No. 63/710,012, filed on Oct. 21, 2024, to Jim Orr, entitled “Portable Fume Extractor,” currently pending, the entire disclosure of which is incorporated herein by reference

### BACKGROUND OF THE INVENTION

For many applications, such as welding, grinding, cutting, sanding, and several others, it is important to capture and collect fumes, dust, debris and other particulate matter created while performing such applications. Various collectors, capture devices and other machines have been created for these applications; however, they often fail to provide complete particulate/fume capture and lack the adaptability desired by users. The present invention is directed to device that solves such issues.

### SUMMARY

The present invention is directed to a portable fume collection system or portable fume extractor configured for capturing dust, fumes, smoke, particulates, debris and other gaseous and particulate matter created during a variety of applications. The portable fume extractor includes a frame formed by one or more panels including a top mount plate. A downdraft table is provided on one side of the top mount plate. A fume capture arm is provided on the opposing side of the top mount plate.

The top mount plate may include a downdraft table opening in the top mount plate that provides fluid communication between the exterior of the frame and the interior of the frame. The downdraft table may include a cover for opening and closing the downdraft table.

The top mount plate may include a capture arm opening in the top mount plate. The capture arm may include an outlet end coupled to the capture arm opening and an inlet end at the opposite end of the capture arm for providing fluid communication between the inlet end of the capture arm and the interior of the frame. The capture arm may include a damper provided at the inlet end for opening and closing the capture arm.

The portable fume extractor may include an internal or external power source. A motor and fan may be positioned within the interior of the frame and may operate to generate reverse airflow or negative pressure at the downdraft table opening and the capture arm opening. When operating, the reverse airflow at the downdraft table may cause fumes, debris and other gaseous and particulate matter adjacent the downdraft table to be collected into the interior of the frame. When operating, the reverse airflow at the capture arm may cause fumes, debris and other gaseous and particulate matter adjacent the inlet end of the capture arm to be collected and transferred into the interior of the frame.

The portable fume extractor may include an exhaust box with a grated exhaust panel to enable airflow through the frame to generate the negative pressure and reverse airflow at the downdraft table and capture arm. The portable fume extractor may include a filter rack for receiving a filter within the interior of the frame and an opening for the filter rack provided through the frame. The portable fume extractor may include a removable dust tray provided within the frame, where ethe removable dust tray may be selective removed from the frame to dispose of collected dust, debris and particulate matter collected in the frame.

Further advantages, features and details of the invention are elucidated on the basis of preferred embodiments thereof, wherein reference is made to the accompanying drawings.

### BRIEF DESCRIPTION OF THE DRAWINGS

In the accompany drawings, which form a part of the specification and are to be read in conjunction therewith in which like reference numerals are used to indicate like or similar parts in the various views:

FIG. 1 is a side perspective view of a portable fume collection system according to one embodiment of the present invention;

FIG. 2 is a partial top perspective view of a downdraft table component of the portable fume collection system of FIG. 1;

FIG. 3 is a top plan view of the portable fume collection system of FIG. 1;

FIG. 4 is a side elevation view of the portable fume collection system of FIG. 1;

FIG. 5 is a front elevation view of the portable fume collection system of FIG. 1; and

FIG. 6 is a partial exploded schematic perspective view of the portable fume collection system of FIG. 1.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is directed to a portable air fume collection system or portable fume extractor 10 that may be used for capturing dust, welding fumes, smoke, particulates, grinding dust, buffing or polishing particulate matter, sanding debris, or other gaseous and/or particulate matter created during welding, sanding and a variety of other applications. The portable fume extractor 10 may be used in various environments and applications, including industrial, commercial and in-home use. The portable fume extractor 10 may be configured as a moveable device that is configured to capture and collect fumes, debris, etc. by two different airflow paths and may be configured as a combination fume extraction arm and downdraft table as described in greater detail below.

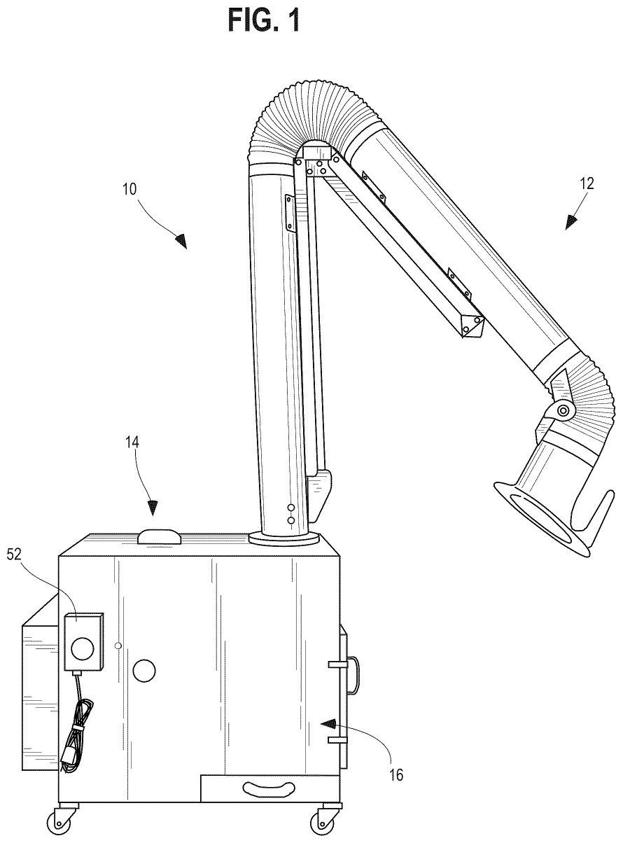

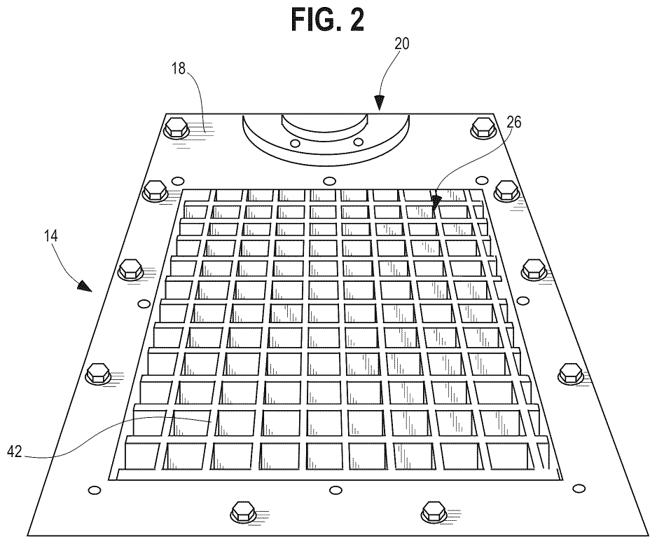

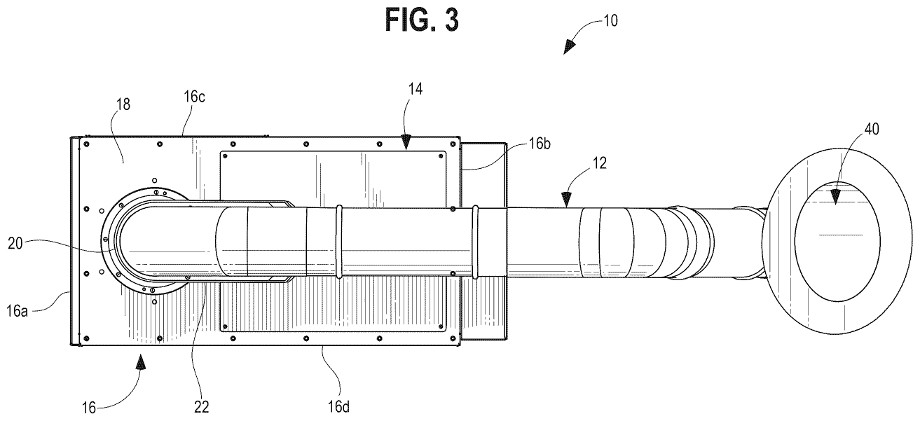

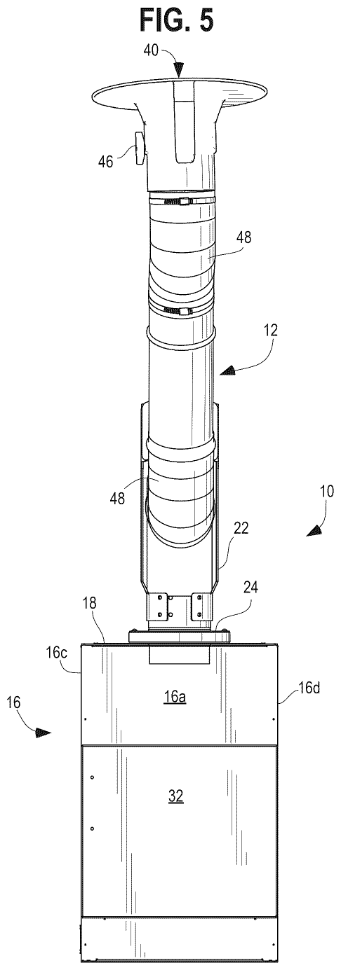

Referring to FIG. 1, the portable fume extractor 10 according to one embodiment includes a moveable capture arm (or snorkel arm) 12 and a downdraft table component 14. As further shown in FIG. 1, the portable fume extractor 10 may include an outer frame 16 formed by one or more panels connected, welded or otherwise attached together to form a box-like frame or shell. Referring to FIGS. 3-6, the upper end of the frame 16 may have a top mount plate 18 attached thereto to provide an upper generally horizontal surface to the extractor 10. The top mount plate 18 may include an extractor arm opening 20 for receiving an outlet end 22 of the capture arm 12. A collar 24 may be provided to connect the outlet end 22 to the opening 20. Adjacent to the extractor arm opening 20 may be a downdraft table opening 26 having a rectangular or other suitable shape (See FIG. 2). The downdraft table opening 26 may be formed as part of the downdraft table component 14. Both the openings 20 and 26 are in fluid communication with the interior of the frame 16.

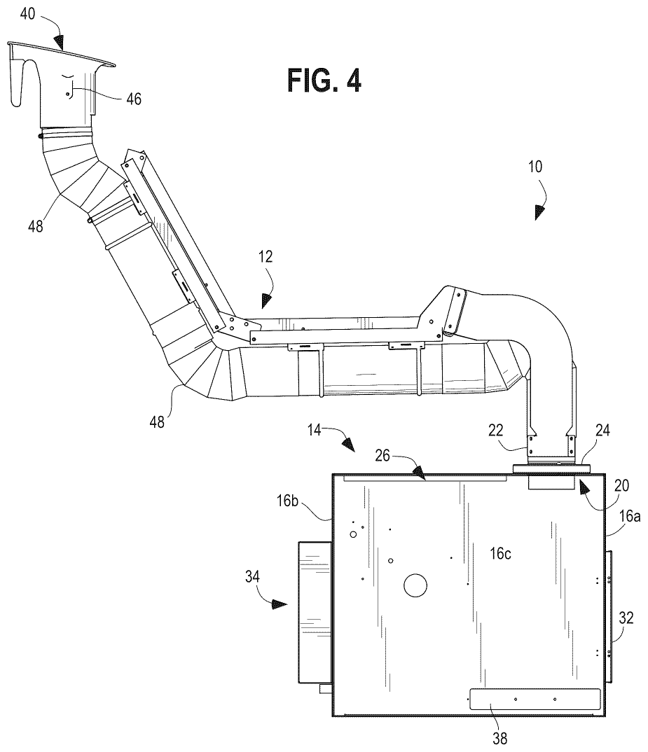

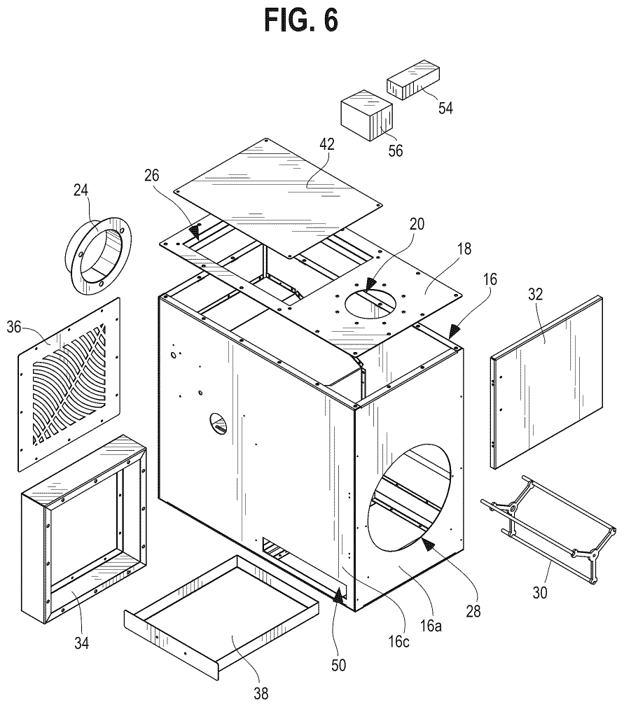

Referring to FIGS. 3-6, the frame 16 may include a first end 16a, second end 16b, first side 16c and second side 16d. As best shown in FIGS. 4 and 6, the first end 16a of the frame 16 may include a filter opening 28 that provides access to the interior of the frame 16. Within the interior of the frame 16 and accessible through the opening 28, a filter rack 30 may be provided for receiving or housing a filter (not shown). The filter rack 30 may be mounted, coupled, or otherwise secured to one or more walls or panels of the frame 16. A pivoting or hinged door panel 32 may be rotatably attached to the first end 16a of the frame 16 for covering the opening 28 and providing selective access thereto. As further shown in FIGS. 4 and 6, the opposing second end 16b of the frame may include an exhaust box 34 that is in fluid communication with and open to the interior of the frame 16. The interior of the frame 16 may be defined by the first and second ends and sides 16a-16d along with the top mount plate 18. A grated exhaust panel 36 having a plurality of openings may be provided within the exhaust box 34. The exhaust box 34 may enable airflow through the frame 16. As further shown in FIG. 6, a removable dust tray 38 may be provided within the lower region of the frame 16. The dust tray 38 may be inserted into an opening 50 in the frame 16 on the first side 16c. The dust tray 38 may capture collected dust and particulate matter captured by the capture arm 12 and/or downdraft table component 14, which may be removed by pulling out the tray 38 from the frame 16 and discarding the contents.

Referring to FIGS. 1 and 3-5, the capture arm 12 may be configured as any adjustable capture arm as known in the art and can include a hose or tubular portion with an outlet end 22 and an inlet end 40. FIG. 6 omits the capture arm 12 solely for purposes of more clearly illustrating the other components of the portable fume extractor; however, it is recognized that the capture arm 12 as illustrated in FIGS. 1 and 3-5 may be included within the extractor 10 illustrated in FIG. 6. As shown in FIGS. 1 and 3-5, the arm 12 may include one or more segments connected by flexible joints 48 for enabling movement and repositioning of the inlet end 40 to a desired location. The arm 12 may be configured from a flexible, semi-flexible and resilient material that enables the arm 12 to be adjusted, deformed, moved, and/or manipulated into a desired location or position. The arm 12 may further include a structural support system for further enabling movement and stability of the arm 12. The arm 12 may further include a damper component 46 provided at the inlet end 40 for selectively opening and closing the inlet end 40 during operation. The damper component 46 may be configured as any suitable damper structure for opening and closing airflow. According to one embodiment, the damper component 46 may be configured as a rotatable structure within the interior of the capture arm that may be moved between an open position, which allows airflow within arm 12 and a closed position, which blocks airflow within arm 12.

Referring to FIGS. 1-3 and 6, the downdraft table component 14 may be provided on the region of the top mount plate 18 opposite the extractor arm 12. The downdraft table component 14 may include opening 26 defined into top mount plate 18. The opening 26 may have a grate panel 42 formed therein. As best shown in FIG. 2, the grate panel 42 may be formed as a gridded structure with a plurality of holes or openings defined therein. As shown in FIG. 1, a removable cover panel 44 may close or cover the opening 26 and grate panel 42 during operation. The downdraft table component 14 may be configured as any suitable downdraft table now know or hereinafter developed. The downdraft table component 14 may operate to create negative pressure or reverse airflow and create a vacuum effect at the grate panel 42 and opening 26 during operation so that fumes, particulate matters, air, etc. at the top side of the opening 26 move through the opening 26 and into frame 16.

The portable fume extractor 10 may include an internal or external power source. A prime mover or motor 54 may be provided within the frame 16 and one or more fans 56 operated by the motor 54 for operating the extractor 10. The motor 54 and fan 56 are illustrated schematically in FIG. 6. The motor 54 and fan 56 may be configured as a standard motor/fan configuration for generating air flow. The portable fume extractor 10 may include an electrical connection 52 for connecting to an external 120V outlet to power the extractor 10 and motor 54 thereof. During operation, the extractor 10 (via the motor and fan 54/56) may generate airflow to provide negative pressure at the inlet end of the capture arm 12 and/or grate panel 42 of the downdraft table 14 in order to capture fume, dust, debris and other particulate matter generated adjacent thereto. The extractor 10 may be configured so that one or both of the downdraft table component 14 and the capture arm 12 are operating to produce a backdraft airflow or negative airflow. According to one embodiment, the extractor 10 may be configured so that both the downdraft table component 14 and capture arm 12 are simultaneously operating. According to one embodiment, the extractor 10 may be configured to provide approximately 1500 CFM airflow; however, it is recognized that extractor 10 may be configured with other airflow ratings. Each component, the capture arm 12 and the downdraft table 14, may be configured and operated in any suitable manner known in the industry.

The extractor 10 may allow for selective use of either the capture arm 12 and/or the downdraft table 14 in order to collect fumes, dust, debris or other matter while performing various functions (e.g., welding, grinding, polishing, etc.). The damper of the capture arm 12 may be closed to direct air to the downdraft table 14. Alternatively, the removable cover panel of the downdraft table 14 may be placed onto the opening of the table 14 and the damper of the capture arm 12 may be opened to direct air to the capture arm 14. The extractor 10 may include wheels or casters proved at the lower end of the frame 16 in order to allow for easy movement and portability of the extractor 10.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations, locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the term “about” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A portable fume collection device comprising:
a frame having a plurality of panels and a top mount plate;
a downdraft table defined into a first region of the top mount plate; and
a fume capture arm provided at a second region of the top mount plate;
wherein the portable fume collection device is configured to create reverse airflow at one or both of the downdraft table and fume capture arm during operation.

2. The portable fume collection device of claim 1, wherein the frame defines and interior below the downdraft table and the fume capture arm.

3. The portable fume collection device of claim 2, further comprising power source located within the interior of the frame and configured to generate airflow for operating the downdraft table and the fume capture arm.

4. The portable fume collection device of claim 3, further comprising a removable cover panel positionable on the downdraft table, wherein the downdraft table is selectively operable by removing the cover panel.

5. The portable fume collection device of claim 4, wherein the fume capture arm comprises an outlet end coupled to the mount plate and an inlet end opposite the outlet end, and a damper provided adjacent the inlet end, wherein the fume capture arm is selectively operable by opening and closing the damper.

6. The portable collection device of claim 1, wherein the downdraft table comprises an opening defined through the top mount plate and a grate panel having a plurality of openings provided within the opening.

7. The portable collection device of claim 1, further comprising a capture arm opening defined through the mount plate and in fluid communication with the interior of the frame, and a collar located at the opening for securing the fume capture arm to the capture arm opening.

8. The portable collection device of claim 1, wherein the fume capture arm includes one or more flexible joints to enable the fume capture arm to be selectively positioned.

9. The portable collection device of claim 1, further comprising a filter located within the frame.

10. The portable collection device of claim 9, further comprising an opening defined into the frame for providing access to the filter.

11. The portable collection device of claim 1, further comprising an exhaust box.

12. The portable collection device of claim 11, wherein the exhaust box comprises a grated exhaust panel having a plurality of openings.

13. A portable fume extractor device comprising:
a frame formed by a plurality of side panels and a top mount plate, the frame having an interior space defined therein;
a motor and a fan located within the interior space of the frame and configured for generating an airflow within the frame;
a downdraft table defined into the top mount plate at a first side thereof; and
a fume capture arm attached to a capture arm opening defined into the top mount plate at a second side thereof;
wherein the portable fume extractor device is configured to create reverse airflow at one or both of the downdraft table and fume capture arm during operation.

14. The portable fume extractor device of claim 13, wherein the downdraft table comprises an opening defined through the top mount plate for providing fluid communication from an upper surface of the top mount plate to the interior space of the frame.

15. The portable fume extractor device of claim 14, wherein the downdraft table further comprises a grated panel having a plurality of openings provided within the opening.

16. The portable fume extractor device of claim 14, wherein reverse airflow is generated at the opening of the downdraft table during operation of the portable fume extractor device.

17. The portable fume extractor device of claim 14, further comprising a removable downdraft table cover positionable over the opening.

18. The portable fume extractor device of claim 13, wherein the fume capture arm comprises an inlet end having a damper configured to selectively move between an open configuration and a closed configuration.

19. The portable fume extractor device of claim 13, wherein the fume capture arm comprises one or more flexible joints.

20. The portable fume extractor device of claim 13, further comprising a filter rack housed within the interior space of the frame.
